(19) United States
(12) Patent Application Publication
(10) Pub. No.: US 2007/0268057 A1
(43) Pub. Date: Nov. 22, 2007

(54) Methods and apparatus for applying changes to a group of objects

(76) Inventors: Vandana Gopal, San Diego, CA (US); Mohanraj Umapathy, San Marcos, CA (US); Philippe Bergman, San Diego, CA (US); William Stone, San Diego, CA (US)

Correspondence Address: QUALCOMM INCORPORATED, 5775 MOREHOUSE DR., SAN DIEGO, CA, 92121, US

(21) Appl. No.: 11/386,121

(22) Filed: Mar. 20, 2006

(51) Int. Cl. G06F 7/00; G06F 1/04

(52) U.S. Cl. 327/295

(57) ABSTRACT

Methods and apparatus for applying changes to a group of objects. A method is provided for applying one or more changes to a group of objects. The method includes communicating the one or more changes to the group of objects at one or more communication times, and receiving one or more acknowledgement signals. The method also includes determining a sync time indicator associated with a selected object, wherein the sync time indicator indicates a time when a selected acknowledgement signal has been received from the selected object for each change communicated prior to the sync time indicator, and comparing the sync time indicator with a last communication time to determine whether the one or more changes have been applied to the selected object.

### BACKGROUND

1. Field

The present invention relates generally to systems for maintaining the state of a collection of objects, and more particularly, to methods and apparatus for applying changes to a set of objects.

2. Background

In large processing systems having multiple objects, it is important that the objects in the system be up-to-date with the latest information. An object could represent data, a program module, or any other type of information. An object could also represent a device in the system. For example, terminals in a wireless communication system may be the objects, and may in fact, contain other objects such as data or program objects.

When a change is being applied to a large collection of objects, it could be a resource intensive operation to apply the change to all objects at once. Typically, the changes are performed using a search and apply technique. For example, each object in the collection is searched to determine its current state. If an object is determined to be up-to-date, no changes are required. If an object is determined to be out-of-date, then changes are applied to bring the object up-to-date.

Unfortunately, the search and apply technique is a resource intensive technique. For example, all the objects in a collection of objects must be searched to determine whether or not they need to be updated. This is a very inefficient process even if the information is locally available, for example, when updating objects within a local system. This becomes even more resource intensive when communication with the objects is performed over a data network, such as a wireless network. For example, if the objects represent a large collection of wireless terminals, then communication with each object is performed over a relatively slow wireless communication channel. As a result, searching each object to determine its current state requires significant bandwidth utilization and thus becomes a very expensive process.

Therefore, what is needed is a way to apply changes to a set of objects that avoids the problems of resource utilization incurred by conventional systems.

### SUMMARY

In one or more embodiments, a change management system is provided that operates to dynamically apply changes to a set of objects. For example, in one embodiment, the system operates to update terminals in a data network so that each terminal is up-to-date with the latest information.

In one embodiment, a method is provided for applying one or more changes to a group of objects. The method comprises communicating the one or more changes to the group of objects at one or more communication times, and receiving one or more acknowledgement signals. The method also comprises determining a sync time indicator associated with a selected object, wherein the sync time indicator indicates a time when a selected acknowledgement signal has been received from the selected object for each change communicated prior to the sync time indicator, and comparing the sync time indicator with a last communication time to determine whether the one or more changes have been applied to the selected object.

In one embodiment, an apparatus is provided for applying one or more changes to a group of objects. The apparatus comprises communication logic configured to communicate the one or more changes to the group of objects at one or more communication times, and receiving logic configured to receive one or more acknowledgement signals. The apparatus also comprises processing logic configured to determine a sync time indicator associated with a selected object, wherein the sync time indicator indicates a time when a selected acknowledgement signal has been received from the selected object for each change communicated prior to the sync time indicator. The processing logic is further configured to compare the sync time indicator with a last communication time to determine whether the one or more changes have been applied to the selected object.

In one embodiment, an apparatus is provided for applying one or more changes to a group of objects. The apparatus comprises means for communicating the one or more changes to the group of objects at one or more communication times, and means for receiving one or more acknowledgement signals. The apparatus also comprises means for determining a sync time indicator associated with a selected object, wherein the sync time indicator indicates a time when a selected acknowledgement signal has been received from the selected object for each change communicated prior to the sync time indicator, and means for comparing the sync time indicator with a last communication time to determine whether the one or more changes have been applied to the selected object.

In one embodiment, a computer-readable media is provided that comprises at least one instruction, which when executed by at least one processor, operates to apply one or more changes to a group of objects. The computer-readable media comprises instructions for communicating the one or more changes to the group of objects at one or more communication times, and instructions for receiving one or more acknowledgement signals. The computer-readable media also comprises instructions for determining a sync time indicator associated with a selected object, wherein the sync time indicator indicates a time when a selected acknowledgement signal has been received from the selected object for each change communicated prior to the sync time indicator, and instructions for comparing the sync time indicator with a last communication time to determine whether the one or more changes have been applied to the selected object.

In one embodiment; at least one processor is provided that is configured to perform a method for applying one or more changes to a group of objects. The method comprises communicating the one or more changes to the group of objects at one or more communication times, and receiving one or more acknowledgement signals. The method also comprises determining a sync time indicator associated with a selected object, wherein the sync time indicator indicates a time when a selected acknowledgement signal has been received from the selected object for each change communicated prior to the sync time indicator, and comparing the sync time indicator with a last communication time to determine whether the one or more changes have been applied to the selected object.

Other aspects of the embodiments will become apparent after review of the hereinafter set forth Brief Description of the Drawings, Detailed Description, and the Claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows a wireless communication network that comprises one embodiment of a change management system;

FIG. 2 shows one embodiment of a server for use in embodiments of a change management system;

FIG. 3 shows a timeline that illustrates the transmission of messages and their acknowledgments during operation of one embodiment of a change management system;

FIG. 4 shows one embodiment of a group cache for use in embodiments of a change management system;

FIG. 5 shows one embodiment of a unit database for use in embodiments of a change management system;

FIG. 6 shows one embodiment of a sync state for use in embodiments of a change management system;

FIG. 7 shows one embodiment of methods for starting and stopping group transmissions for use in embodiments of a change management system;

FIG. 8 shows one embodiment of a method for providing unit transmissions for use in embodiments of a change management system;

FIG. 9 shows one embodiment of a method for completing unit transmissions for use in embodiments of a change management system;

FIG. 10 shows one embodiment of a method for processing acknowledgment signals for use in embodiments of a change management system; and

FIG. 11 shows one embodiment of a method for evaluating the state of a terminal for use in embodiments of a change management system.

### DETAILED DESCRIPTION

In one or more embodiments, a change management system is provided that operates to dynamically apply changes to a group of objects. For example, the system may be used to apply changes to a group of software object modules in a local computer system, to a group of computer systems in a data network, or to a group of remote terminals in a communication network. For simplicity and clarity, the system is described herein with reference to applying changes to a group of mobile terminals that communicate over a wireless network. However, it should be noted that embodiments of the system are equally applicable to apply changes to virtually any type of group having hardware and/or software objects that are locally and/or remotely available.

In a wireless network implementation, the system operates to apply changes to a large number of mobile terminals. The changes may comprise configuration information that is periodically updated and is used by the terminals to operate on the network. In one embodiment, the system operates to associate the state of a particular terminal with a sync time indicator that can be quickly and efficiently accessed. The system utilizes the sync time indicator to determine if the terminal has missed any transmissions subsequent to the sync time, and if it has, the system re-transmits the missed transmissions the next time the terminal communicates. Thus, the system operates to apply changes to a group of terminals without having to perform an intensive analysis to determine the state of each terminal every time a change is to be applied. The system is suitable for use in virtually any type of communication system, and is especially well suited for operation with wireless communication networks.

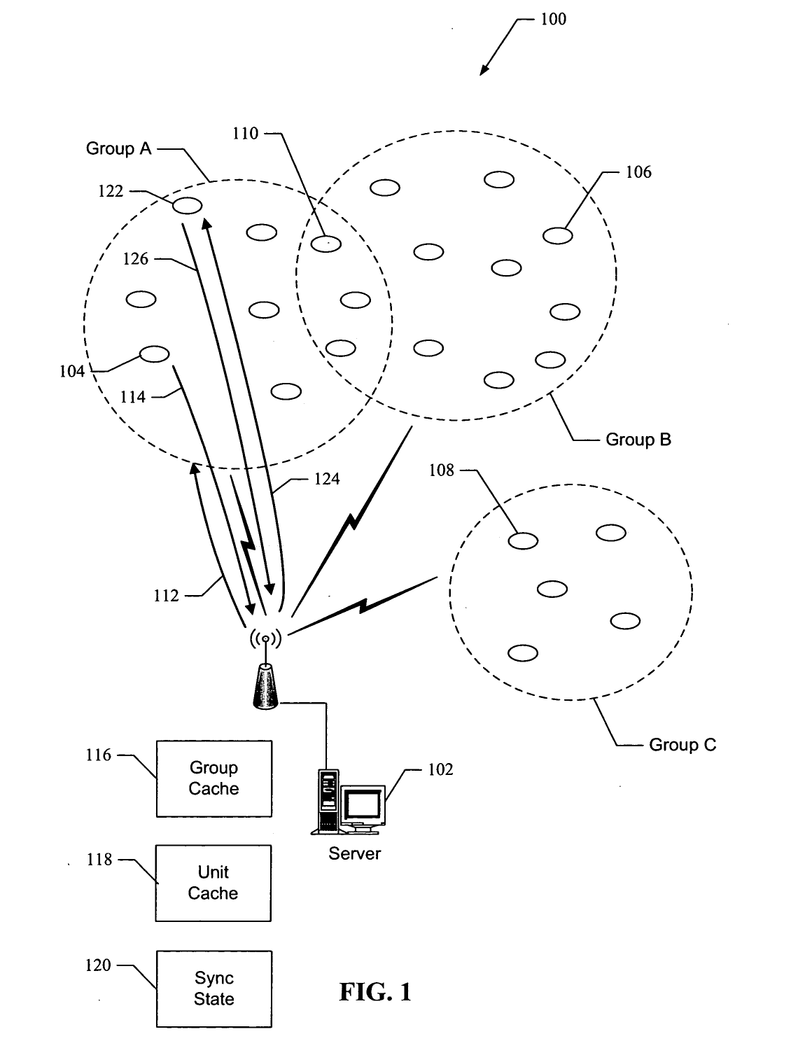

FIG. 1 shows a wireless communication network 100 that comprises one embodiment of a change management system. The communication network 100 comprises a server 102 which is capable of wirelessly communicating with a number of mobile terminals. For example, the server 102 may communicate with the mobile terminals to provide any type of program, executable, script, multimedia file, data file, configuration information, information updates, and/or any other type of information.

It will be assumed for this description that the terminals are organized into groups. A group may comprise any number of terminals. For example, Group A comprises a number of terminals that include terminals 104 and 122, Group B comprises a number of terminals that include terminal 106, and Group C comprises a number of terminals that include terminal 108. It will further be assumed that any terminal may belong to more than one group. For example, terminal 110 belongs to both Group A and Group B.

The server 102 comprises processing logic that operates to transmit information to the terminals in the three groups. In one embodiment, the server 102 operates to provide group transmissions that are targeted to all terminals within a selected group. The server also operates to provide unit transmissions that are targeted to a particular terminal having a selected unit address. Thus, in one or more embodiments, the system operates to apply changes to an entire group or to a particular terminal utilizing the group transmissions and the unit transmissions, respectively.

In one embodiment, the server 102 operates to maintain a group cache 116. The group cache 116 comprises time indicators that describe when group transmissions from the server 102 begin and end.

In one embodiment, the server 102 operates to maintain a unit cache 118. The unit cache 118 comprises time indicators that describe when group and unit transmissions are acknowledged by a particular terminal.

In one embodiment, the server 102 operates to determine a sync state 120. The sync state 120 comprises sync time indicators that describe a point in time where all previous group or unit transmissions to a particular terminal have been acknowledged. In one embodiment, each terminal described in the sync state 120 may be associated with one or more groups and have a separate sync time indicator for each group.

Group Transmissions

In one embodiment, the system operates to apply changes to a group of terminals using a group transmission. For example, the server 102 transmits information to Group A, as shown by path 112, and terminals that are part of Group A acknowledge the receipt of the information by sending an acknowledgement. For example, the terminal 104 receives the group transmission 112 and transmits an acknowledgement signal 114 back to the server 102 to indicate that it received the transmission 112. Because the server 102 may transmit a large number of group transmissions over the course of time, it operates to maintain the state of each terminal with regards to the group transmissions it has received. Thus, upon transmission, the server 102 updates group transmission indicators in the group cache 116, and when the server 102 receives acknowledgements from any of the terminals it operates to update acknowledgement time indicators in the unit cache 118. The server 102 also operates to update and maintain the sync state 120 for the responding terminals. If a terminal fails to acknowledge a group transmission, the system operates to retransmit the information to the terminal in a unit transmission.

Unit Transmissions

In one embodiment, the system operates to apply changes to an individual terminal using unit transmissions. For example, the server 102 transmits a unit transmission 124 to the terminal 122, which acknowledges the transmission by transmitting an acknowledgement signal 126 back to the server 102 to indicate that it received the unit transmission 124. Because the server 102 may transmit a large number of unit transmissions over the course of time, it operates to maintain the state of each terminal with regards to the unit transmissions it has received. Thus, upon transmission, the server 102 updates unit transmission indicators in the unit cache 118, and when the server 102 receives acknowledgements from any of the terminals it operates to update acknowledgement indicators, which are also part of the unit cache 118. The server 102 also operates to update and maintain state characteristics in the sync state 120 for the responding terminals. For example, the sync time associated with a responding terminal may be updated as acknowledgments from that terminal are received.

Synchronization Determination

In one embodiment, the system operates to make a synchronization determination when a terminal communicates with the server 102. For example, a terminal may communicate with the server 102 after being out of range or after powering on. A terminal may also communicate with the server 102 during any other normal operation. For example, a terminal may communicate with the server 102 to acknowledge a received transmission, report its status, request information, or for any other reason.

When a terminal communicates with the server 102, the server 102 operates to determine if a prior unit transmission to the terminal is pending or has failed. If a prior unit transmission is pending, the system operates to give the targeted terminal time to acknowledge the pending transmission. If a prior unit transmission has failed (i.e., the terminal has not acknowledged the prior unit transmission within a selectable time duration), then the system then attempts to retransmit the information in another unit transmission to the terminal.

If there are no prior pending or failed unit transmissions, the server 102 operates to make a synchronization determination to determine if the latest group changes have been applied to the terminal. In one embodiment, the server 102 operates to compare time indicators in the group cache 116 to sync time indicators in the sync state 120. If it is determined that the terminal has failed to acknowledge a completed group transmission, the system operates to re-transmit the unacknowledged information to the terminal in one or more unit transmissions.

Therefore, embodiments of the change management system operate to apply changes to a group of objects by performing one or more of the following functions.
1. Transmit group or unit transmissions to apply changes to one or more objects (terminals).
2. Maintain a group cache that comprises time indicators associated with group transmissions.
3. Maintain a unit cache that comprises time indicators associated with object acknowledgements.
4. Maintain a sync state that comprises sync time indicators that identify a synchronization state associated with the objects with respect to group and unit transmissions.
5. Wait for an object to communicate.
6. Determine if there are pending or failed unit communications to the object.
7. If there are pending communications to the object, wait to see if the object responds within a selectable time interval.
8. If there are failed unit communications to the object, attempt to re-transmit the failed unit communications.
9. If there are no pending or failed unit communications to the object, determine if the object is synchronized by comparing time indicators in the group cache to sync time indicators associated with the object.
10. If the object is not synchronized, retransmit unacknowledged group transmissions to the object in unit transmissions.

Therefore, as a result of the operation of embodiments of the change management system, it is possible to quickly and efficiently apply changes to a group of objects and maintain the state of objects in each group.

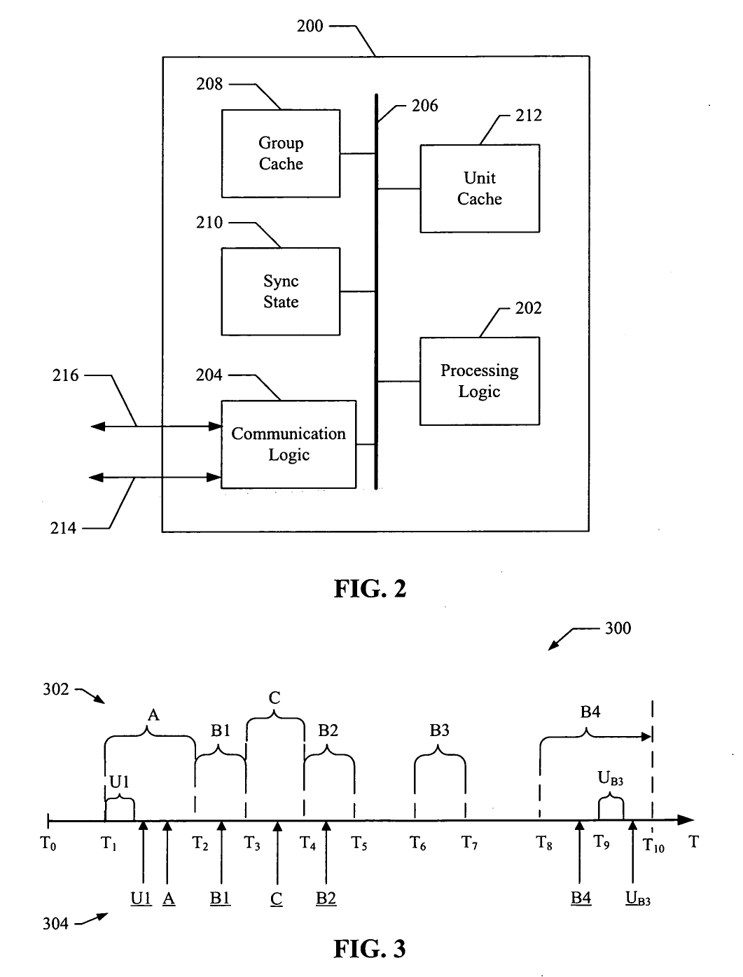

FIG. 2 shows one embodiment of a server 200 for use in embodiments of a change management system. For example, the server 200 is suitable for use as the server 102 shown in FIG. 1.

The server 200 comprises processing logic 202 and communication logic 204, which are coupled to a data bus 206. The server 200 also comprises a group cache 208, a sync state 210 and a unit cache 212, which are also coupled to the data bus 206.

In one or more embodiments, the processing logic 202 comprises a CPU, processor, gate array, hardware logic, memory elements, virtual machine, software, and/or any combination of hardware and software. Thus, the processing logic 202 generally comprises logic to execute machine-readable instructions and to control one or more other functional elements of the server 200 via the internal data bus 206.

The communication logic 204 comprises hardware and/or software that operate to allow the server 200 to transmit and receive data and/or other information to/from objects in a group. In one embodiment, the communication logic 204 comprises logic configured to provide transmissions to a group of objects. For example, the communication logic 204 comprises logic to communicate with a group of software objects, hardware objects, or remote terminals. For example, in one embodiment, the communication logic 204 comprises a multicast/broadcast transmission channel 214 or other type of communication channel that provides communications with a group of objects. The communication logic 204 also comprises logic configured to provide transmissions to a particular object. For example, the communication logic 204 comprises a unit transmission channel 216, such as a unicast channel or other type of communication channel that provides communications with a particular object.

Using the communication logic 204, the server 200 is able to transmit messages comprising any type of information to one or more groups of terminals or to a particular terminal. For example, the messages may comprise configuration information or any other type of information. The communication logic 204 also comprises logic configured to receive an acknowledgment signal from a terminal to indicate that it received a transmission from the server 200. The acknowledgement signal comprises any type of acknowledgment in response to one or more transmitted messages. Additionally, the transmitted messages and/or the acknowledgement signals may have any suitable format and utilize any suitable encoding or encryption technology.

In one embodiment, the group cache 208 comprises any suitable type of memory device operable to store transmission time indicators associated with group transmissions from the server 200. For example, the group transmissions may comprise a message transmitted to a selected terminals associated with one or more groups.

In one embodiment, the unit cache 212 comprises any suitable type of memory device operable to store time indicators associated with acknowledgement signals received from one or more terminals. In one embodiment, terminals identified in the unit cache 212 are associated with groups to which they belong. The time indicators describe a point in time when a transmission was started and when an acknowledgement signal was received at the server 200.

In one embodiment, the sync state 210 comprises any suitable type of memory device operable to store sync time indicators associated with one or more terminals. For example, the sync time indicators are determined by the processing logic 202 from the information in the unit cache 212. In one embodiment, a sync time for a selected terminal with respect to a particular group indicates a time when the terminal has received and acknowledged all group transmissions to the terminal previous to the sync time.

The sync state 210 also comprises a pending indicator P that indicates the status of unit transmissions to a particular terminal. For example, the pending indicator is set to “in progress” to indicate that at least one unit transmission to a particular terminal is currently pending. The pending indicator is set to “stale” to indicate that at least one unit transmission to a particular terminal has failed. The pending indicator may also be set to a particular time value to indicate a time when all prior unit transmissions to a particular terminal have been acknowledged.

During operation of one embodiment of the change management system, the processing logic 202 operates to update the group cache 208 and the unit cache 212 based on transmissions from the server 200. When acknowledgement signals are received from one or more terminals, the processing logic 202 operates to update the unit cache 212 and determine sync time indicators that are stored as part of the sync state 210.

When a terminal communicates with the server 200, the processing logic 202 first determines if the terminal has any failed or pending unit transmissions by checking the pending indicator associated with the terminal. If the pending indicator indicates that a prior unit transmission to the terminal has failed, the system attempts to re-transmit any missed messages to the terminal. If the pending indicator indicates that at least one unit transmission is currently pending, the system allows the transmission time to complete. If the pending indicator does not indicate a failed or pending transmission, the processing logic 202 obtains the terminal's sync time indicator from the sync state 210 and compares it to transmission time indicators stored in the group cache 208. If the sync time indicator is later than the group transmission time indicators, then the state of the terminal is determined to be up-to-date. If the sync time indicator is earlier than the group transmission time indicators, then the state of the terminal is determined to be out of synchronization.

In one embodiment, if the terminal is determined to be out of synchronization, the processing logic 202 then determines which group transmissions the terminal has failed to acknowledge, and re-transmits the information in those unacknowledged transmissions to the terminal in unit transmissions. When those re-transmissions begin, the pending condition for the terminal is set to “in progress” to indicate that unit transmissions are pending. For example, the processing logic 202 sets the pending indicator in the sync state 210 that is associated with that terminal.

In one embodiment, the change management system comprises program instructions stored on a computer-readable media, which when executed by at least one processor, for instance, the processing logic 202, provides the functions of the server 200 described herein. For example, instructions may be loaded into the server 200 from a computer-readable media, such as a floppy disk, CDROM, memory card, FLASH memory device, RAM, ROM, or any other type of memory device or computer-readable media. In another embodiment, the instructions may be downloaded into the server 200 from an external device or network resource that interfaces to the server 200 via the communication logic 204. The instructions, when executed by the processing logic 202, provide one or more embodiments of a change management system as described herein. It should be noted that the server 200 is just one implementation and that other implementations are possible within the scope of the embodiments.

FIG. 3 shows a timeline 300 that illustrates the transmission of messages and their acknowledgments during operation of one embodiment of a change management system. For example, the messages shown on the timeline 300 may comprise configuration information that is transmitted from the server 102 to the terminals shown in FIG. 1.

The timeline 300 shows messages 302 transmitted to the terminals 108 and 110 shown in FIG. 1. The timeline 300 illustrates that a group transmission (A) is transmitted to Group A beginning at time T1 and ending at time T2. A unit transmission (U1) to terminal 108 begins at time T1. Another group transmission (C) is transmitted to Group C beginning at time T3 and ending at time T4. The timeline 300 also shows four group transmissions (B1-B4) transmitted to Group B. The transmissions to Group B have start times of T2, T4, T6 and T8, respectively. The first three Group B transmissions have end times at T3, T5, and T7, respectively. The last Group B transmission (B4) is shown as still being transmitted and so no end time is shown for that transmission.

The timeline 300 also shows acknowledgment signals 304 received from the terminals 108 and 110 in response to the transmitted messages. As illustrated in FIG. 1, the terminal 110 belongs to both Groups A and B. Thus, as illustrated by the timeline 300, the terminal 110 acknowledged the group transmission A at A, and acknowledged the group transmissions B1, B2 and B4, at B1, B2, and B4, respectively. Furthermore, the terminal 108 acknowledged the unit transmission U1 at U1, and the group transmission C at C.

It should be noted that the transmission B3 was not acknowledged by terminal 110. As a result, the system performs a unit transmission to the terminal 110 as shown at U_{B3} in response to receiving the acknowledgment signal B4. For example, when the terminal 110 acknowledged the B4 group transmission at B4, communications with the terminal 110 were established. In response to communicating with the terminal 110, the system operated to determine that the group transmission B3 was not acknowledged, and so the system re-transmitted the B3 message to the terminal 110 in the unit transmission U_{B3}. During the unit transmission U_{B3} the pending status indicator is set “in progress” for the terminal 110 to indicate that a unit transmission is pending to the terminal 110. The pending indicator of “in progress” will exist until the terminal 110 either acknowledges the re-transmission or the re-transmission times out or otherwise fails. For example, a timeout occurs if the terminal 110 fails to acknowledge the retransmission within a selected time interval. As illustrated in the timeline 300, the terminal 110 acknowledges the unit transmission U_{B3} at U_{B3}. If there are no other unit transmissions pending to the terminal 110, the pending status indicator will be set to the time when the acknowledgment signal U_{B3} is received. A more detailed description of the operation of the pending status indicator is provided in another section of this document.

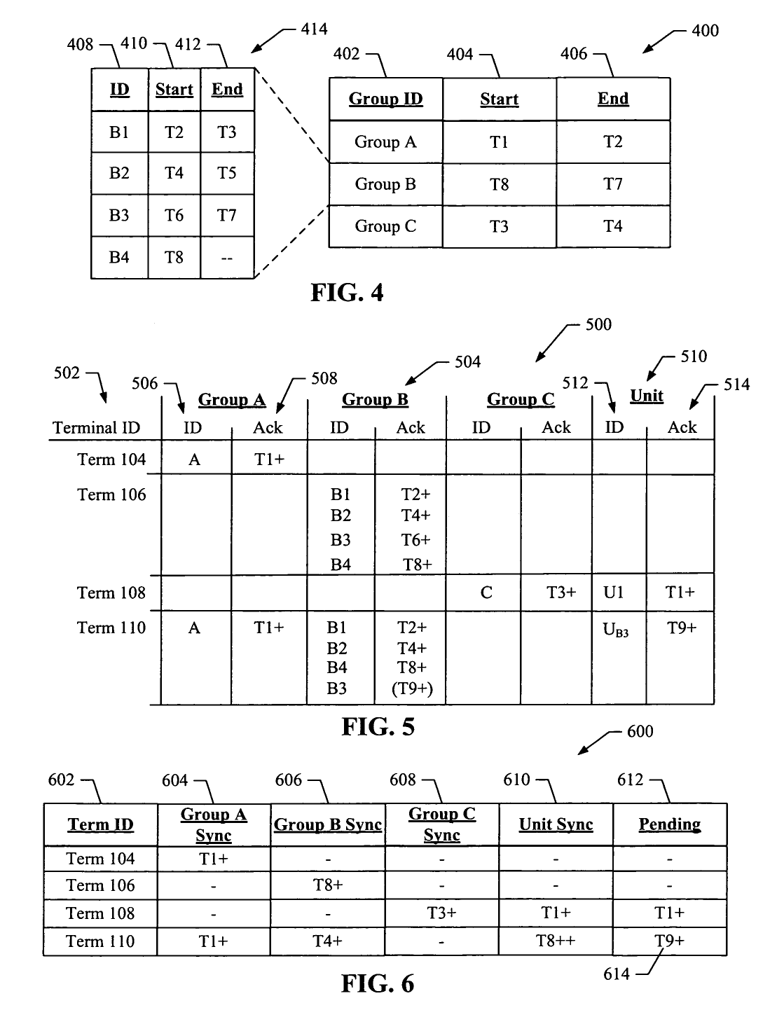

FIG. 4 shows one embodiment of a group cache 400 for use in embodiments of a change management system. The group cache 400 is suitable for use as the group cache 208 shown in FIG. 2, or as the group cache 116 shown in FIG. 1. In one embodiment, the processing logic 202 operates to update and maintain the group cache 400 with information about group transmissions from the server 200.

In one embodiment, the group cache 400 comprises information from one or more group databases. For example, a group database 414 is shown that comprises information related to Group B transmissions. The database 414 comprises a transmission identifier (ID) 408, a transmission start time 410 and a transmission end time 412. In one or more embodiments, a database similar to the database 414 is provided for each group.

It should be noted that the group database 414 may be of any length and may describe information about a sequence of messages or different versions of a particular message. For example, as additional new messages are transmitted, the group database 414 is updated to include that information at the end of the database 414. However, if a new version of a previously transmitted message is transmitted, the start and end times of that message will be updated based on its message identifier. For example, if a new version of the message identified as “B3” is transmitted, the entries in the database 414 related to message identifier B3 will be updated with the new transmissions times. Thus, the database 414 operates to describe both new messages and new versions of previously transmitted messages. The database 414 may also be maintained in any suitable fashion so that unneeded entries are removed as necessary.

The group cache 400 comprises a group identifier (ID) 402, a group transmission start time indicator 404, and a group transmission end time indicator 406. The group ID 402 identifies a group comprising one or more terminals to which one or more group messages are transmitted. For example, the terminals in Group A may comprise the terminals shown in Group A illustrated in FIG. 1. The transmission start time indicator 404 indicates a time when the most recent group transmission to a group is started. The transmission end time indicator 406 indicates a time when the most recent transmission to a group has ended.

The group cache 400 comprises entries that describe the group messages illustrated in the timeline 300 shown in FIG. 3. As illustrated in FIG. 3, the most recently transmitted message in Group A has a start time of T1, and the most recently completed message in Group A has an end time of T2. Similarly, the most recently transmitted message in Group C has a start time of T3, and the most recently completed message in Group C has an end time of T4.

With regards to Group B, the most recently transmitted message in Group B has a start time of T8, which is determined from the message B4 and illustrated in the group database 414. However, the most recently completed message in Group B has an end time of T7, which is determined from the message B3, and which is also illustrated in the group database 414.

Thus, the group cache 400 describes the start and end times of the most recent messages transmitted to each group. In one or more embodiments, these times are used to determine if a terminal is up-to-date (or synchronized) with the latest information for a particular group.

FIG. 5 shows one embodiment of a unit cache 500 for use in embodiments of a change management system. For example, the unit cache 500 may be used as the unit cache 118 in FIG. 1. The unit cache 500 comprises information describing acknowledgements received from one or more terminals. The unit cache 500 comprises a terminal identifier 502, group identifiers 504, and for each identified group there are message identifiers 506 and acknowledgement times 508 that describe when an acknowledgement for particular group transmissions are received. In addition to the group identifiers 504, the unit cache also comprises a unit identifier 510 that comprises unit message identifiers 512 and unit acknowledgement times 514 that describe when acknowledgements for particular unit transmissions are received.

For the purpose of this description, the information shown for the terminals 104 and 106 are provided for illustrative purposes. The information shown for terminals 108 and 110 are derived from the timeline 300 shown in FIG. 3. It should be noted that the unit cache 500 comprises information describing both unit and group transmissions to any terminal.

For the following description, it will be assumed that the terminal 110 is a member of Groups A and B as shown in FIG. 1. Referring to the unit cache 500 and with reference to the terminal 110, a Group A message (A) was transmitted at time T1 and an acknowledgment signal from terminal 110 was received sometime afterwards, as indicated by T1+. Group B messages (B1, B2, B4) were transmitted at times T2, T4, and T8. Acknowledgment signals in response to the Group B messages were received from terminal 110 at times T2+, T4+, and T8+.

With regards to the Group B message (B3) which was transmitted at time T6, no acknowledgement signal was received from the terminal 110. As a result, the system waits until the terminal 110 communicates an acknowledgement at B4 and then re-transmits the Group B message (B3) in a unit transmission, as shown by the designator U_{B3} that begins at T9. The terminal 110 then acknowledges the unit transmission at T9+. That acknowledgement is also reflected in the Group B acknowledgment times for the transmission B3 to the terminal 110. The timeline 300 ends at time T10 and so transmissions or acknowledgements after T10 are not described herein.

As each message is transmitted and acknowledgments are received, the processing logic 202 operates to update the information in the unit cache 500. In one or more embodiments, the information in the unit cache 500 is used to generate a sync state (i.e., sync state 210) as described in the following sections of this document.

FIG. 6 shows one embodiment of a sync state 600 for use in embodiments of a change management system. For example, the sync state 600 may be part of the sync state 120 shown in FIG. 1, or the sync state 210 in FIG. 2.

The sync state 600 comprises a terminal identifier (ID) 602, group sync time indicators 604, 606, 608, and unit sync time indicator 610, which correspond to synchronization times for Groups A, B, C, and unit transmissions. The sync state 600 also comprises a pending indicator 612. It should be noted that the pending indicator 612 may also be part of the unit cache 500. The terminal ID 602 identifies a particular terminal to which information is transmitted. The sync time indicators (604, 606, 608, and 610) indicates a point in time when a particular terminal is in sync with all previous transmissions (group or unit) directed to that terminal. For example, terminal 104 is synchronized up to time T1+ for Group A transmissions. The pending indicator 612 indicates that a unit transmission is pending (i.e., when P=“in progress”), a unit transmission has failed (i.e., when P=“stale”) or that all unit transmissions up to a particular time indicator have been acknowledged (i.e., when P=a particular time indicator).

In one embodiment, the sync time indicators 604, 606, 608, and 610 are determined from the group database 414 and unit cache 500. For example, a group sync time indicator is determined for each terminal by evaluating the group database 414 and the unit cache 500 to determine a point in time where all messages to a particular group have been acknowledged by that terminal. A unit sync time indicator is determined for each terminal by evaluating the unit cache 500 to determine a point in time where all unit messages to that terminal have been acknowledged. Thus, with regards to unit 104, all messages in Group A have been acknowledged by terminal 104 at time T1+. A similar process can be used to determine the synchronization times for the other terminals.

With regards to the terminal 110, the sync time takes into consideration transmissions for Group A, Group B, and unit transmissions. For Group A, all messages prior to time T1+ have been acknowledged by terminal 110. For Group B, all messages prior to time T4+ have been acknowledged by terminal 110. Assuming that T1+ occurs before T4+, and that T4+ occurs before T6+, the sync time for terminal 110 with respect to Group B transmissions is T4+. It should be noted that the determined sync time does not change because the terminal 110 has acknowledged a Group B transmission at time T8+. This is because at time T8+ the transmission at time T6 has not been acknowledged. Thus, time T4+ is the point in time when all prior Group B transmissions have been acknowledged by the terminal 110.

Because the group transmission B3 was not acknowledged, a unit transmission (U_{B3}) to terminal 110 is started at time T9. The unit transmission contains the information of group transmission B3 and is started after the terminal communicates the acknowledgement B4. When the unit transmission begins, the pending indicator 614 associated with terminal 110 is set to “in progress” to indicate that a unit transmission is pending. When the terminal 110 acknowledges the unit transmission at T9+, the pending indicator is set to T9+if there are no other failed or pending unit transmissions to that terminal. It should be noted that in one embodiment, after the unit transmission (U_{B3}) is acknowledged at time T9+, the sync time indicator for the terminal 110 with respect to group B transmissions may be updated to show that the terminal is synced up to time T9+.

In one or more embodiments, the sync time indicator for each terminal with respect to each transmission type is updated if necessary as acknowledgements are received. The sync time indicator indicates a point in time when the terminal has acknowledged all prior messages for each transmission type (group and unit) that are transmitted to it.

It should be noted that the sync state 600 is just one implementation and that other implementations are possible within the scope of the embodiments.

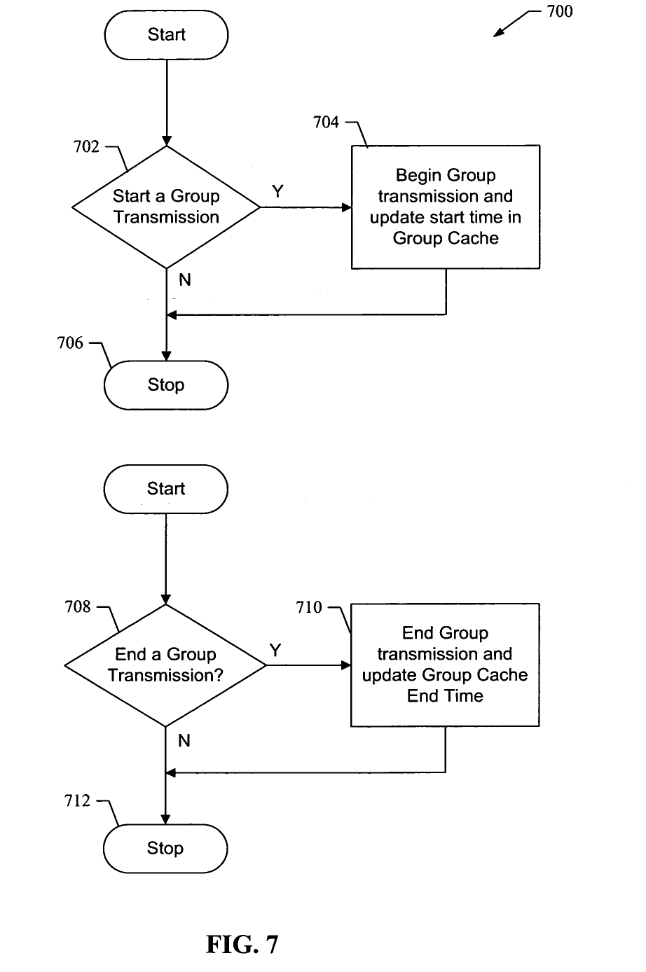

FIG. 7 shows one embodiment of methods 700 for starting and ending group transmissions for use in embodiments of a change management system. In one embodiment, the processing logic 202 executes one or more instructions to control the operation of the server 200 to perform the functions described below. It should be noted that the method 700 may be performed concurrently with any other method described herein.

At block 702, a test is performed to determine if a group transmission needs to be started. For example, the processing logic 202 determines if there are any group messages that need to be transmitted to one or more groups. If a group transmission does not need to be started, the method stops at block 706. If a group transmission needs to be started the method proceeds to block 704.

At block 704, the group transmission is started and the group cache is updated. For example, the group cache 208 is updated to reflect the group transmission start time. In one embodiment, the processing logic 202 controls the communication logic 204 to start the group transmission and then updates the group transmission start time in the group cache 208. In one embodiment, information describing group transmissions is also maintained in one or more group databases. The method then ends at block 706.

At block 708, a test is performed to determine if a group transmission needs to be ended. For example, the processing logic 202 determines if there are any group transmissions that need to be ended. If a group transmission does not need to be ended, the method stops at block 712. If a group transmission needs to be ended the method proceeds to block 710.

At block 710, the group transmission is ended and a group cache is updated. For example, the group cache 208 is updated to reflect the group transmission end time. In one embodiment, the processing logic 202 controls the communication logic 204 to end the group transmission and then updates the group transmission end time in the group cache 208. The method then stops at block 712.

Thus, the methods 700 operates to begin and end group transmissions as necessary and maintain transmission start and end times in the group cache 208. As a result, the group cache 208 contains the most recent transmission start and end times for any particular group. It should be noted that the method 700 illustrates just one implementation and that changes, additions, deletions, combinations, and/or rearrangements of the described functions may be made without deviating from the scope of the described embodiments.

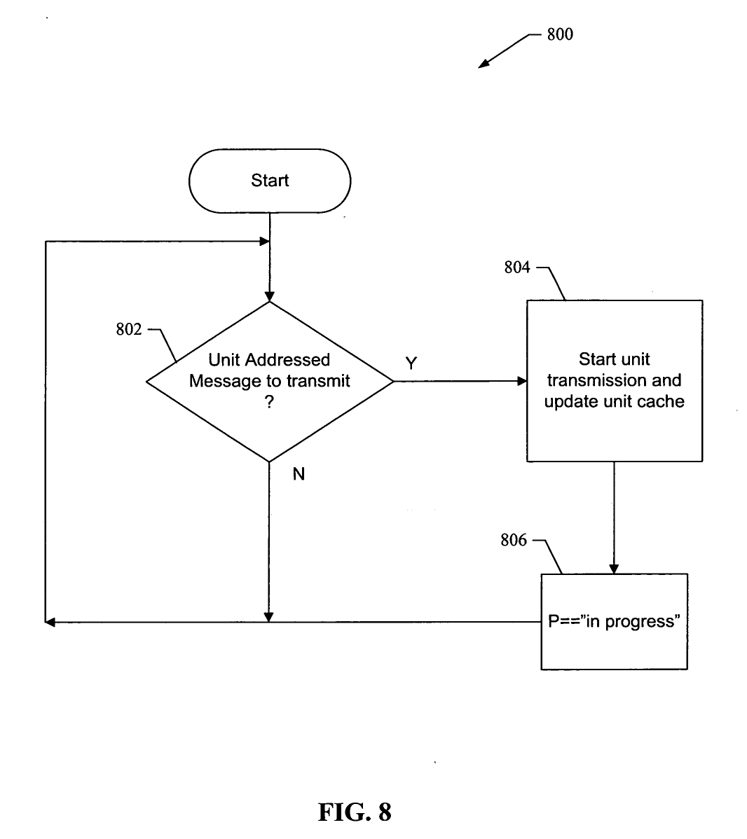

FIG. 8 shows one embodiment of a method 800 for providing unit transmissions for use in embodiments of a change management system. In one embodiment, the processing logic 202 executes one or more instructions to control the operation of the server 200 to perform the functions described below. It should be noted that the method 800 may be performed concurrently with any other method described herein.

At block 802, a test is performed to determine if a unit transmission needs to be started. For example, the processing logic 202 determines if there are any messages that need to be transmitted as unit transmissions to a selected terminal. For example, there may exist unit messages that need to be transmitted or unacknowledged group messages that need to be re-transmitted as unit messages. If a unit transmission does not need to be started, the method proceeds back to block 802 to continue testing for unit transmissions. If a unit transmission needs to be started the method proceeds to block 804.

At block 804, the unit transmission is started and a unit cache is updated. For example, the unit cache 212 is updated to reflect the unit transmission start time. In one embodiment, the processing logic 202 controls the communication logic 204 to start the unit transmission and then updates the unit start time in the unit cache 212.

At block 806, a pending indicator is set to “in progress” to indicate that a unit transmission is pending. For example, the processing logic 202 sets the pending indicator 612 in a sync state 600 to indicate that a unit transmission is currently pending to a particular terminal. For example, the pending indicator is set to “in progress.” The method then proceeds to block 802 to determine if there are more unit transmissions.

Thus, the method 800 operates to begin unit transmissions as necessary and maintain transmission start times in the unit cache 212. The method 800 also updates the pending indicator in the sync state 600 to indicate when a unit transmission is pending. It should be noted that the method 800 illustrates just one implementation and that changes, additions, deletions, combinations, and/or rearrangements of the described functions may be made without deviating from the scope of the described embodiments.

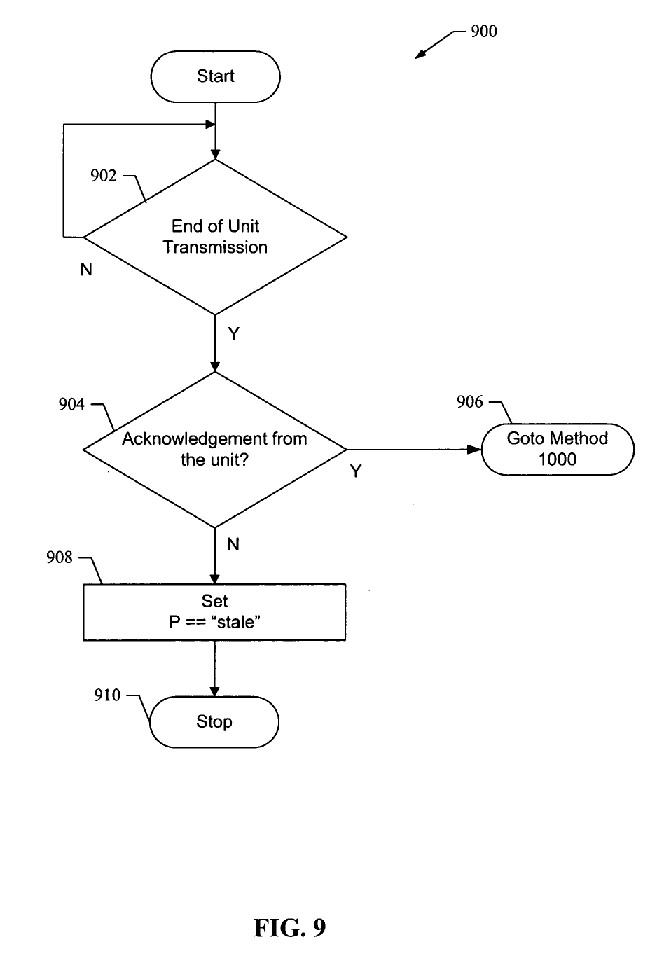

FIG. 9 shows one embodiment of a method 900 for completing unit transmissions for use in embodiments of a change management system. In one embodiment, the processing logic 202 executes one or more instructions to control the operation of the server 200 to perform the functions described below. It should be noted that the method 900 may be performed concurrently with any other method described herein.

At block 902, a test is performed to determine if a unit transmission has completed. For example, the processing logic 202 determines if a unit transmission has completed. If a unit transmission has not completed, the method proceeds back to block 902 to continue testing for unit transmission completions. If a unit transmission has completed the method proceeds to block 904.

At block 904, a test is performed to determine if the completed unit transmission was acknowledged. For example, when a unit receives a unit transmission, it responds by transmitting an acknowledgement signal. Thus, if an acknowledgement has been received, the method proceeds to block 906. If an acknowledgement has not been received, the method proceeds to block 908.

At block 906, the method proceeds to the method 1000 where acknowledgments are processed. A more detailed description of the method 1000 is provided in another section of this document.

At block 908, the pending indicator for the terminal is set to “stale.” This indicates that the unit transmission to the terminal has failed. The method then stops at block 910.

Thus, the method 900 operates to process the completion of unit transmissions and update a pending indicator to indicate any failed unit transmissions. It should be noted that the method 900 illustrates just one implementation and that changes, additions, deletions, combinations, and/or rearrangements of the described functions may be made without deviating from the scope of the described embodiments.

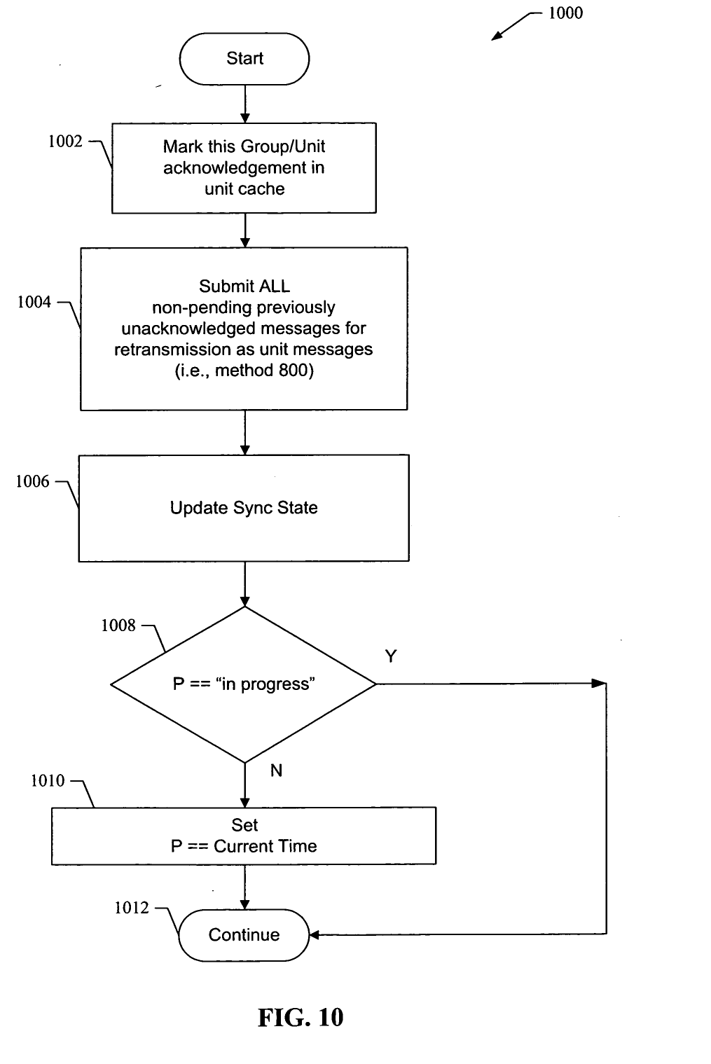

FIG. 10 shows one embodiment of a method 1000 for processing acknowledgment signals for use in embodiments of a change management system. In one embodiment, the processing logic 202 executes one or more instructions to control the operation of the server 200 to perform the functions described below. It should be noted that the method 1000 may be performed concurrently with any other method described herein.

At block 1002, the time of a received acknowledgement signal is marked in a unit cache. For example, in response to either a group or unit transmission a terminal transmits an acknowledgement signal that is received by the communication logic 204 and passed to the processing logic 202. The processing logic 202 operates to update the unit cache 212 to include the time the acknowledgement was received. For example, the time is marked in the appropriate acknowledgement 508 column with respect to the terminal transmitting the message.

At block 1004, all non-pending previously unacknowledged messages are submitted for re-transmission to the acknowledging terminal. For example, the method 800 is used to transmit all non-pending unacknowledged messages in unit transmissions to the terminal. The method 800 also sets pending status indicator to “in progress” if any unit messages are transmitted.

At block 1006, the sync state of the terminal from which communications have been received is updated if necessary. For example, the received acknowledge signal may result in changing the sync time of the communicating terminal. For example, the new acknowledgement signal may change the point in time when all prior transmissions relative to a particular group or unit have been acknowledged. Thus, the sync time indicator will be updated if necessary to reflect this.

At block 1008, a test is performed to determine if there are any pending communications to the communicating terminal. For example, the operation of the block 1004 may result in one or more pending communications to the terminal. If there are any pending communications, the pending status indicator will be set to “in progress.” If this is the case, the method continues at block 1012. If there are no pending communications, the method proceeds to block 1010.

At block 1010, the pending status indicator for the terminal is set to the current time. For example, the processing logic 202 sets the pending status indicator in the sync state 600 to the current time.

Thus, the method 1000 operates to process received acknowledge signals from a communicating terminal and initiate unit transmissions for any missed messages. It should be noted that the method 1000 illustrates just one implementation and that changes, additions, deletions, combinations, and/or rearrangements of the described functions may be made without deviating from the scope of the described embodiments.

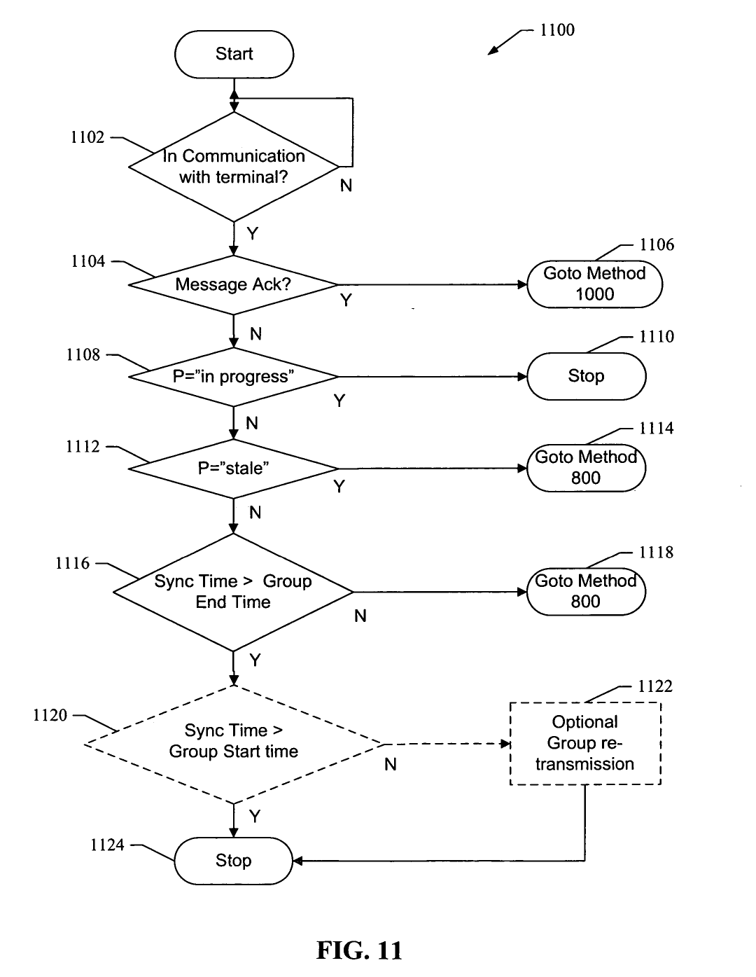

FIG. 11 shows one embodiment of a method 1100 for evaluating the state of a terminal for use in embodiments of a change management system. For example, the method 1100 is suitable for use with the server 200 shown in FIG. 2 to evaluate the state of terminals with respect to any group or unit transmission. In one embodiment, the processing logic 202 executes program instructions to control the functional elements of the server 200 to provide the functions described below. In one embodiment, the server 200 comprises at least one processor configured to perform the method 1100. It should be noted that the method 1100 may be performed concurrently with any other method described herein.

At block 1102, a test is performed to determine if a terminal is currently in communication with the server. For example, a terminal may have been out of range or in a power-down mode and may not have communicated with the server over an extended time period. Terminal communications are received by the communication logic 402 and passed to the processing logic 202. If there are no terminal communications, the method continues at block 1102 to wait to receive a communication from a terminal. If a terminal is communicating with the server, the method proceeds to block 1104.

At block 1104, a test is performed to determine if the communication from the terminal is an acknowledgement signal. For example, the communication may be an acknowledgement signal acknowledging a group or unit transmission. In one embodiment, the processing logic 202 operates to determine if the communication from the terminal is an acknowledgement signal. If the communication comprises an acknowledgement signal, the method proceeds to block 1106. If the communication is not an acknowledgment signal, the method proceeds to block 1108.

At block 1106, the method proceeds to the method 1000 to process the received acknowledgement signal. For example, the processing logic 202 determines that the communication is an acknowledgement signal and operates to perform the method 1000 described above to process the received acknowledgement and start any additional re-transmissions that may be necessary.

At block 1108, a test is performed to determine if the pending indicator for the communicating terminal is set to “in progress.” In one embodiment, the processing logic 202 operates to test the pending status indicator in the sync state 600 to determine if a unit transmission is currently pending to the terminal. If a unit transmission is pending, the method stops at block 1110 to allow the transmission to complete. If a unit transmission is not pending, the method proceeds to block 1112.

At block 1112, a test is performed to determine if the pending indicator for the communicating terminal is set to “stale.” In one embodiment, the processing logic 202 operates to test the pending status indicator in the sync state 600 to determine if a unit transmission to the terminal has failed. For example, if the pending status indicator is set to “stale” a unit transmission to the terminal has failed. If a unit transmission has failed, the method proceeds to block 1114. If a unit transmission has not failed, the method proceeds to block 1116.

At block 1114, the method proceeds to the method 800 to submit messages for unit re-transmissions to the terminal. For example, the processing logic 202 operates to perform the method 800 described above to re-transmit failed unit transmissions and start any additional re-transmissions that may be necessary.

At block 1116, a test is performed to determine if the terminal is in sync. In one embodiment, the processing logic 202 operates to retrieve the sync time from the sync state 600 and transmission time indicators from the group cache 400 to determine if the unit is in synchronization with all changes. For example, the sync time in the sync state 600 is compared to the group end time for a particular group. If the sync time is later than the group end time then the terminal is in sync with changes to that group. The process is repeated for other group for which the terminal may belong. If the sync time is early than the a group end time, then at least one group transmission has not been acknowledged so that the terminal is not is synchronized. The method then proceeds to block 1118. If the terminal is in synchronization with all groups, then the method proceeds to block 1120.

At block 1118, the method proceeds to the method 800 to submit messages for unit re-transmissions to the terminal. For example, the processing logic 202 operates to perform the method 800 described above to re-transmit unacknowledged group transmissions and start any additional re-transmissions that may be necessary.

At block 1120, an optional test is performed to determine if there is a group transmission that has been started but has not been acknowledged by the terminal. For example, the processing logic 202 operates to process the group cache 400 to determine if the group start time for any group is later than the terminal's sync time. If this is the case, then a group transmission has begun that has not been acknowledged by the terminal. The method proceeds to block 1122. If the sync time is later than any group start time, then there are no group transmissions that still need to be acknowledged and the method stops at block 1124.

At block 1122, an optional group re-transmission occurs. In one embodiment, the processing logic 202 controls the communication logic 204 to re-transmit the ongoing group transmission. For example, the ongoing group transmission may be scheduled to occur periodically over several days. Because the terminal's sync time is not later than the group transmission's start time, the terminal has not yet acknowledged this group transmission. Because the terminal is now in communication with the server, a one time (“one-shot”) group re-transmission is performed to allow this terminal (and any other terminals in the group) to receive the group message. The method then stops at block 1124.

Thus, the method 1100 is suitable for evaluating the state of a communicating terminal in embodiments of a change management system. It should be noted that the method 1100 illustrates just one implementation and that changes, additions, deletions, combinations, and/or rearrangements of the described functions may be made without deviating from the scope of the described embodiments.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

Accordingly, while one or more embodiments of a change management system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

What is claimed is:

1. A method for applying one or more changes to a group of objects, the method comprising:
communicating the one or more changes to the group of objects at one or more communication times;
receiving one or more acknowledgement signals;
determining a sync time indicator associated with a selected object, wherein the sync time indicator indicates a time when a selected acknowledgement signal has been received from the selected object for each change communicated prior to the sync time indicator; and
comparing the sync time indicator with a last communication time to determine whether the one or more changes have been applied to the selected object.

2. The method of claim 1, wherein said communicating comprises communicating the one or more changes to the group of objects in one or more group transmissions.

3. The method of claim 1, further comprising determining that a re-communication to the selected object is not pending.

4. The method of claim 1, further comprising determining that a re-communication to the selected object has not failed.

5. The method of claim 1, further comprising determining that the one or more changes have been applied to the selected object if the last communication time is earlier than the sync time indicator.

6. The method of claim 1, further comprising:
determining that the sync time indicator is earlier than the last communication time;
determining a portion of the one or more changes that have been communicated after the sync time indicator and for which corresponding acknowledgement signals have not been received; and
re-communicating the portion of the one or more changes to the selected object.

7. The method of claim 6, wherein said re-communicating comprises re-communicating the portion of the one or more changes in one or more unit transmissions.

8. Apparatus for applying one or more changes to a group of objects, the apparatus comprising:
communication logic configured to communicate the one or more changes to the group of objects at one or more communication times;
receiving logic configured to receive one or more acknowledgement signals;
processing logic configured to determine a sync time indicator associated with a selected object, wherein the sync time indicator indicates a time when a selected acknowledgement signal has been received from the selected object for each change communicated prior to the sync time indicator, and wherein the processing logic is further configured to compare the sync time indicator with a last communication time to determine whether the one or more changes have been applied to the selected object.

9. The apparatus of claim 8, wherein said communication logic comprises logic to communicate the one or more changes to the group of objects in one or more group transmissions.

10. The apparatus of claim 8, further comprising logic configured to determine that a re-communication to the selected object is not pending.

11. The apparatus of claim 8, further comprising logic configured to determine that a re-communication to the selected object has not failed.

12. The apparatus of claim 8, further comprising logic configured to determine that the one or more changes have been applied to the selected object if the last communication time is earlier than the sync time indicator.

13. The apparatus of claim 8, further comprising:
logic configured to determine that the sync time indicator is earlier than the last communication time;
logic configured to determine a portion of the one or more changes that have been communicated after the sync time indicator and for which corresponding acknowledgement signals have not been received; and
logic configured to re-communicate the portion of the one or more changes to the selected object.

14. The apparatus of claim 13, wherein said logic configured to re-communicate comprises logic configured to re-communicate the portion of the one or more changes in one or more unit transmissions.

15. Apparatus for applying one or more changes to a group of objects, the apparatus comprising:
means for communicating the one or more changes to the group of objects at one or more communication times;
means for receiving one or more acknowledgement signals;
means for determining a sync time indicator associated with a selected object, wherein the sync time indicator indicates a time when a selected acknowledgement signal has been received from the selected object for each change communicated prior to the sync time indicator; and
means for comparing the sync time indicator with a last communication time to determine whether the one or more changes have been applied to the selected object.

16. The apparatus of claim 15, wherein said means for communicating comprises means for communicating the one or more changes to the group of objects in one or more group transmissions.

17. The apparatus of claim 15, further comprising means for determining that a re-communication to the selected object is not pending.

18. The apparatus of claim 15, further comprising means for determining that a re-communication to the selected object has not failed.

19. The apparatus of claim 15, further comprising means for determining that the one or more changes have been applied to the selected object if the last communication time is earlier than the sync time indicator.

20. The apparatus of claim 15, further comprising:
means for determining that the sync time indicator is earlier than the last communication time;
means for determining a portion of the one or more changes that have been communicated after the sync time indicator and for which corresponding acknowledgement signals have not been received; and
means for re-communicating the portion of the one or more changes to the selected object.

21. The apparatus of claim 20, wherein said means for re-communicating comprises means for re-communicating the portion of the one or more changes in one or more unit transmissions.

22. A computer-readable media comprising at least one instruction, which when executed by at least one processor, operates to apply one or more changes to a group of objects, the computer-readable media comprising:
instructions for communicating the one or more changes to the group of objects at one or more communication times;
instructions for receiving one or more acknowledgement signals;
instructions for determining a sync time indicator associated with a selected object, wherein the sync time indicator indicates a time when a selected acknowledgement signal has been received from the selected object for each change communicated prior to the sync time indicator; and
instructions for comparing the sync time indicator with a last communication time to determine whether the one or more changes have been applied to the selected object.

23. The computer-readable media of claim 22, wherein said instructions for communicating comprise instructions for communicating the one or more changes to the group of objects in one or more group transmissions.

24. The computer-readable media of claim 22, further comprising instructions for determining that a re-communication to the selected object is not pending.

25. The computer-readable media of claim 22, further comprising instructions for determining that a re-communication to the selected object has not failed.

26. The computer-readable media of claim 22, further comprising instructions for determining that the one or more changes have been applied to the selected object if the last communication time is earlier than the sync time indicator.

27. The computer-readable media of claim 22, further comprising:
instructions for determining that the sync time indicator is earlier than the last communication time;
instructions for determining a portion of the one or more changes that have been communicated after the sync time indicator and for which corresponding acknowledgement signals have not been received; and
instructions for re-communicating the portion of the one or more changes to the selected object.

28. The computer-readable media of claim 27, wherein said instructions for re-communicating comprise instructions for re-communicating the portion of the one or more changes in one or more unit transmissions.

29. At least one processor configured to perform a method for applying one or more changes to a group of objects, the method comprising:
communicating the one or more changes to the group of objects at one or more communication times;
receiving one or more acknowledgement signals;
determining a sync time indicator associated with a selected object, wherein the sync time indicator indicates a time when a selected acknowledgement signal has been received from the selected object for each change communicated prior to the sync time indicator; and
comparing the sync time indicator with a last communication time to determine whether the one or more changes have been applied to the selected object.

30. The method of claim 29, wherein said communicating comprises communicating the one or more changes to the group of objects in one or more group transmissions.

31. The method of claim 29, further comprising determining that a re-communication to the selected object is not pending.

32. The method of claim 29, further comprising determining that a re-communication to the selected object has not failed.

33. The method of claim 29, further comprising determining that the one or more changes have been applied to the selected object if the last communication time is earlier than the sync time indicator.

34. The method of claim 29, further comprising:
determining that the sync time indicator is earlier than the last communication time;
determining a portion of the one or more changes that have been communicated after the sync time indicator and for which corresponding acknowledgement signals have not been received; and
re-communicating the portion of the one or more changes to the selected object.

35. The method of claim 34, wherein said re-communicating comprises re-communicating the portion of the one or more changes in one or more unit transmissions.
